(19) United States
(12) Patent Application Publication
(10) Pub. No.: US 2009/0278930 A1
(43) Pub. Date: Nov. 12, 2009

(54) IMAGE SURVEILLANCE SYSTEM AND METHOD THEREOF

(76) Inventors: Tao-Ming Chueh, Taipei City (TW); Wei-Chang Chen, Taipei City (TW); Kuo-Wei Lee, Taipei City (TW)

Correspondence Address: SINORICA, LLC, 2275 Research Blvd., Suite 500, ROCKVILLE, MD, 20850, US

(21) Appl. No.: 12/176,445

(22) Filed: Jul. 21, 2008

(30) Foreign Application Priority Data
May 8, 2008 (TW) 097116946

(51) Int. Cl. H04N 7/18

(52) U.S. Cl. 348/143; 348/E07.085

(57) ABSTRACT

An image surveillance system and a method thereof are disclosed. The image surveillance system comprises an image-capturing apparatus, which connects to the Internet, and has an IP address for capturing an image of a predetermined area to produce a digital image signal. At least a display device connects to the Internet. The display device comprises a frame body which resembles a conventional picture frame, a search engine, a receiver and a monitor which are all disposed in the frame body, and a microprocessor which is disposed in the frame body and connects to the search engine, the receiver, and the monitor to lock down the IP address of the image-capturing apparatus so as to make the digital image signal be captured and displayed.

### BACKGROUND OF THE INVENTION

1. Technical Field

The present invention relates to an image surveillance system and a method thereof. More particularly, the present invention relates to a system and a method serving to connect a display device with an image-capturing apparatus having an IP address through the Internet.

2. Description of Related Art

While people have paid more and more attention to their daily life security in the modern society, installing video security systems has become a popular means to inform people of the status quo in some predetermined areas so as to ensure the safety of their living environments. However, the video security systems are usually expansive. Especially, when there are more areas to be monitored, more monitors and video cameras are required, resulting in expenses too high for ordinary users to afford. Even after such video security system is installed, since maintenance thereof is subject to professional technicians, in the event the system fails or gets damaged, its user for the most part has no way to repair it by himself/herself. When some devices of the system need to be replaced, the cost is also significant. By the aforementioned reasons, the conventional video security systems are unaffordable to ordinary users and thus a need existing for improving the conventional video security systems.

On the other hand, a conventional digital picture frame, descended from the conventional picture frame, to be erected on a table or hung on a wall, serves to display a single static photograph. Though the conventional digital picture frame somehow fulfills a decorative or memorial purpose, it fails to provide additional applications other than photo presentation and thus needs to be improved.

### SUMMARY OF THE INVENTION

The present invention provides an improved image surveillance system and a method thereof for remedying the foregoing problems. More particularly, one objective of the present invention is to propose a system and a method serving to connect a display device with an image-capturing apparatus having an IP address through the Internet so as to provide a surveillance system economically affordable to ordinary users.

Another objective of the present invention is to provide an improved image surveillance system and a method thereof serving to real-time monitor the status quo at some predetermined areas so as to ensure the safety of its users' living environments.

Another objective of the present invention is to provide an improved image surveillance system and a method thereof uniting functions of static photo presentation as the conventional picture frame and dynamic image presentation as a digital picture frame.

Another objective of the present invention is to provide an improved image surveillance system and a method thereof adding additional applications to a conventional digital picture frame.

Still another objective of the present invention is to provide an improved image surveillance system and a method thereof wherein devices contained in the system are cost effective so as to save expenses and enhance managerial efficiency.

Yet another objective of the present invention is to provide an improved image surveillance system and a method thereof, wherein a monitor thereof serves to automatically search an image-capturing apparatus so as to achieve more effective and instant management.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIGS. 1A and 1B are schematic drawings describing a conventional wall-mounted picture frame;

FIGS. 2A and 2B are schematic drawings describing a conventional free-standing picture frame;

FIG. 3 is a schematic drawing illustrating a first preferred embodiment of an image surveillance system of the present invention;

FIG. 4 is a schematic drawing illustrating a second preferred embodiment of an image surveillance system of the present invention;

FIG. 5 is a schematic drawing illustrating a first preferred embodiment of an image surveillance method of the present invention; and

FIG. 6 is a schematic drawing illustrating a second preferred embodiment of an image surveillance method of the present invention.

### DETAILED DESCRIPTION OF THE PREFERRED EMBODIMENT

The following description will be directed to a plurality of preferred embodiments of the present invention as depicted in the accompany drawings wherein each of the involved components is allotted with a respective numeral in expectation of enabling people skilled in the art to accomplish or implement the disclosed subject matter of the present invention by reading the following description in conjunction with the accompanying drawings.

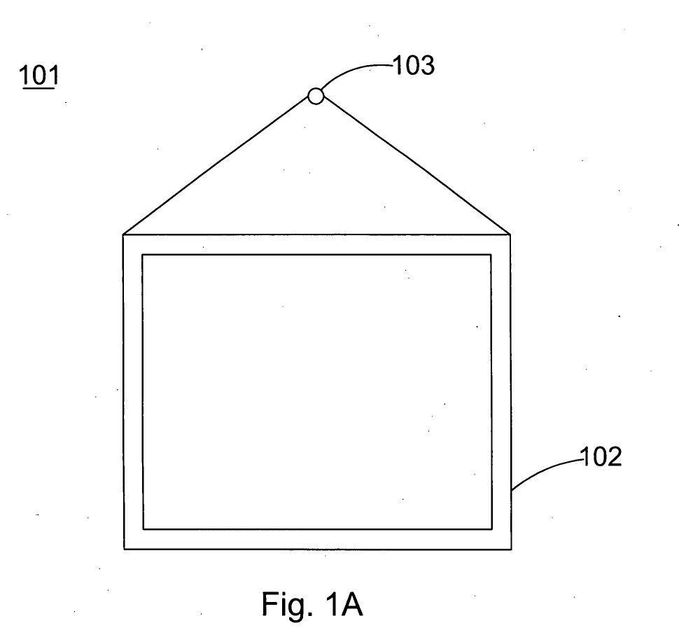

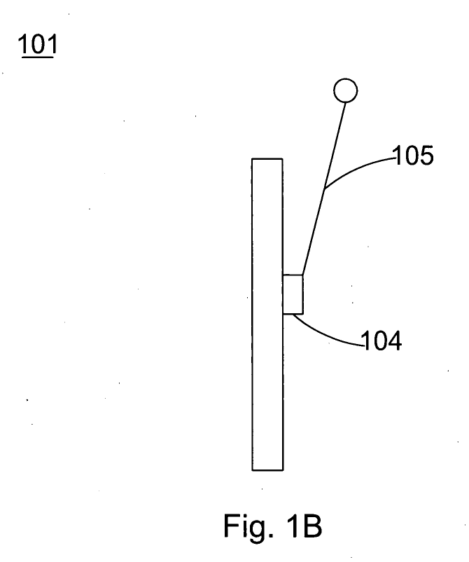

Please refer to FIGS. 1A and 1B for schematic drawings describing a conventional wall-mounted picture frame 101. The conventional wall-mounted picture frame 101 comprises a frame body 102, a connecting portion 104 provided at a rear side of the frame body 102, and a rope 105 attached to the connecting portion 104 for hanging the frame body 102 on a fixing portion 103 that is fixedly attached to a wall (not shown), thereby the conventional wall-mounted picture frame 101 being hung on the wall for a presentation purpose.

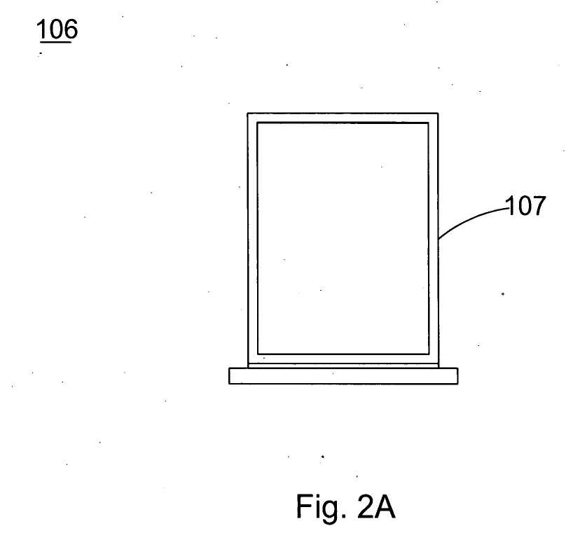

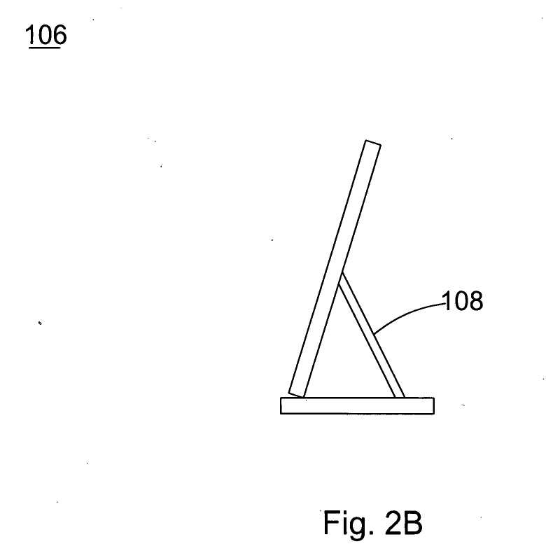

Now please refer to FIGS. 2A and 2B for schematic drawings describing a conventional free-standing picture frame 106. The conventional free-standing picture frame 106 comprises a frame body 107 and a support 108 provided at a rear side of the frame body 107 so that the conventional free-standing picture frame 106 can stand on a plane on the strength of an included angle between the frame body 107 and the support 108.

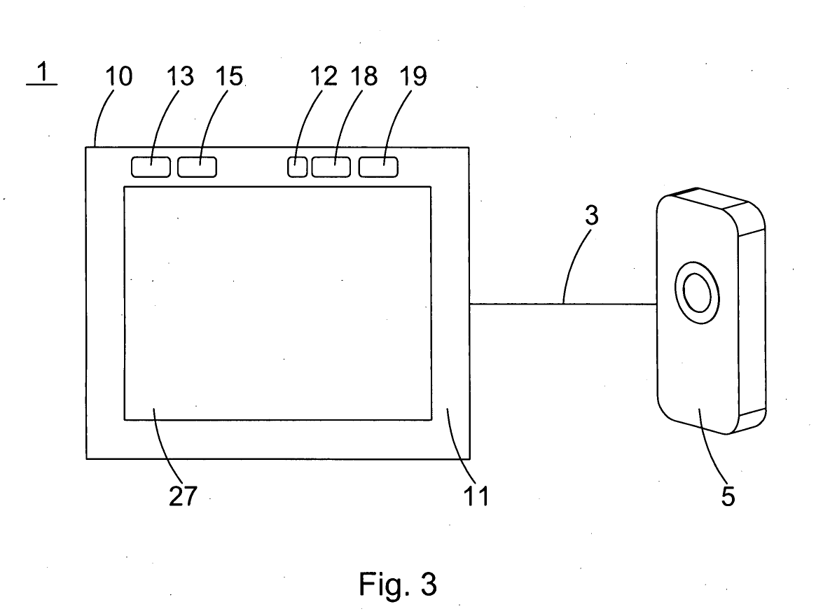

Reference is now made to FIG. 3 that illustrates a first preferred embodiment of an image surveillance system of the present invention. Therein, an image surveillance system 1 connects to the Internet 3 and comprises at least one image-capturing apparatus 5 connecting to the Internet 3 for capturing an image of a predetermined area to produce at least one digital image signal. The image-capturing apparatus 5 has an IP (Internet Protocol) address. Moreover, at least one display device 10 also connects to the Internet 3.

The display device 10 comprises a frame body 11 which resembles a conventional picture frame, a search engine 13 that is settled in the frame body 11 for searching the IP address of the image-capturing apparatus 5, a receiver 15 that deposited in the frame body 11 for receiving the digital image signal from the image-capturing apparatus 5, a monitor 17 settled in the frame body 11 for displaying the digital image signal of the image-capturing apparatus 5, and a microprocessor 18 also disposed in the frame body 11 and connecting to the search engine 13, the receiver 15, and the monitor 17 to lock down the IP address of said image-capturing apparatus 5 so as to make the digital image signal be captured and displayed.

The display device 10 further comprises an input interface (not shown) connecting to and controlling the microprocessor 18. The input interface serves to input the IP address of the image-capturing apparatus 5, and may be a keyboard, a remote control or a mouse externally connecting to the display device 10. Alternatively, the input interface may be included in the display device 10 as a touch screen or a remote-controlled device. The image surveillance system 1 further comprises a storage device 19 arranged in the frame body 11 for storing the digital image signal of the image-capturing apparatus 5.

In the disclosed system, the image-capturing apparatus 5 may be an IP camera and the display device 10 may be a digital picture frame that comprises a memory card socket for receiving a memory card, wherein the memory card may be used to store images or codes. The display device 10 and the Internet 3 may be connected mutually in a wired or wireless manner. In the case that the display device 10 and the Internet 3 are connected in the wireless manner, a wireless transmission technology such as Wi-Fi (Wireless fidelity), infrared transmission, RF (Radio Frequency) or BlueTooth is implemented. Besides, a data transmission between the image-capturing apparatus 5 and the display device 10 may rely on TCP/IP (Transmission Control Protocol/Internet Protocol).

The image-capturing apparatus 5 further has a security mechanism and the display device 10 further includes a transmitter 12 connecting to the microprocessor 18 for transmitting an information conforming to the security mechanism so that the display device 10 is allowed to capture the digital image signal from the image-capturing apparatus 5. The information transmitted by the transmitter 12 is a preset code and may be pre-stored in the display device 10 or may be input to the display device 10 through the input interface.

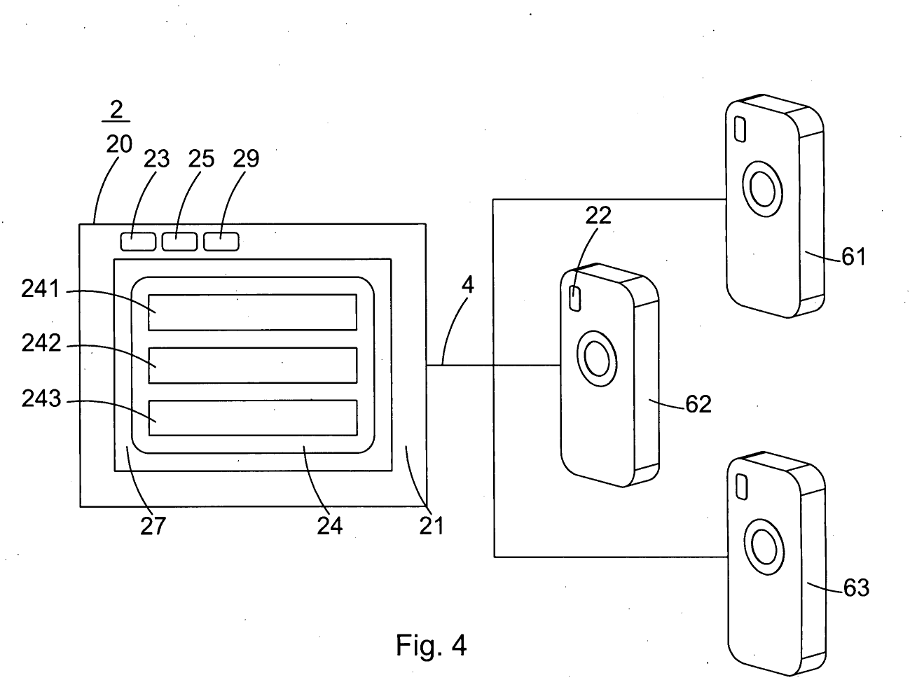

Now referring to FIG. 4, a second preferred embodiment of the image surveillance system 2 of the present invention connects to the Internet 4 and comprises image-capturing apparatuses 61, 62, 63 connecting to the Internet 4 for capturing an image of a predetermined area to produce at least one digital image signal. Each of the image-capturing apparatuses 61, 62, 63 has an IP address. Moreover, at least one display device 20 also connects to the Internet 4. The display device 20 comprises a frame body 21 which resembles a conventional picture frame, a broadcasting device 23 that is settled in the frame body 21 for sending a preset command to the image-capturing apparatuses 61, 62, 63, and a receiver 25 that deposited in the frame body 21 for receiving the digital image signals from the image-capturing apparatuses 61, 62, 63.

The image surveillance system 2 also includes a monitor 27 deposited on the frame body 21 for displaying the digital image signals of the image-capturing apparatuses 61, 62, 63. A menu 24 displayed on the monitor 27 and a microprocessor 29 is disposed in the frame body 21 and connects to said broadcasting device 23, said receiver 25, and said monitor 27 to lock down said IP addresses of said image-capturing apparatuses 61, 62, 63, so as to capture and display the digital image signals. Each of the image-capturing apparatuses 61, 62, 63 further comprises a responding device 22. When receiving the preset command from the display device 20, the responding device 22 responds with a preset information so as to present the image-capturing apparatuses 61, 62, 63 in the menu 24 of the display device 20. By the cooperation of the broadcasting device 23 and the responding device 22, each said display device 20 can reach each said image-capturing apparatuses 61, 62, 63 in a same LAN automatically without manual search. The menu 24 comprises menu icons 241, 242 and 243. The menu icons 241, 242 and 243 represent the image-capturing apparatuses 61, 62 and 63, respectively. If clicking the menu icons 241, for example, the image which image-capturing apparatus 61 receives will be shown on the monitor 27. If clicking the menu icons 242, the image which image-capturing apparatus 62 receives will be shown on the monitor 27. If clicking the menu icons 243 the image which image-capturing apparatus 63 receives will be shown on the monitor 27.

The display device 20 further comprises an input interface (not shown)(??) for connecting to and controlling the microprocessor 29. The input interface serves to select one of said image-capturing apparatuses 61, 62, 63 from the menu 24 presented on the display device 20 for capturing and displaying the digital image signal. The data transmitted between each of the image-capturing apparatuses 61, 62, 63 and the display device 20 relies on UDP (User Datagram Protocol).

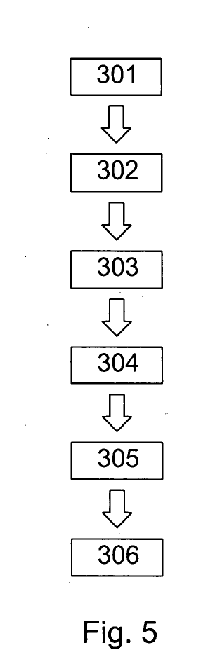

The present invention further provides an image surveillance method including following steps as shown in FIG. 5:

Step 301, implementing at least one image-capturing apparatus having an IP address to capture an image of a predetermined area to produce a digital image signal;

Step 302, providing a display device connecting to the image-capturing apparatus through the Internet, wherein the display device comprises a microprocessor and a search engine, a receiver as well as a monitor that connect to the microprocessor;

Step 303, using the search engine settled in the display device to search the IP address of the image-capturing apparatus;

Step 304, using the receiver settled in the display device to receive the digital image signal from the image-capturing apparatus; Step 305, using the microprocessor settled in the display device to lock down the IP address of the image-capturing apparatus so a to make the digital image signal be captured and displayed; and

Step 306, using the monitor settled in the display device to display the digital image signal of the image-capturing apparatus.

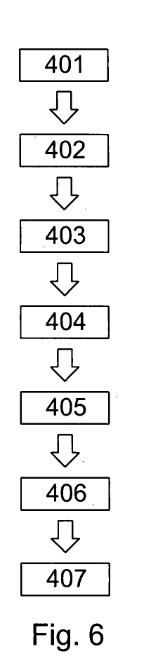

The present invention further provides another image surveillance method including following steps as shown in FIG. 6:

Step 401, providing a display device, which comprises a microprocessor and a search engine, a receiver, a broadcasting device as well as a monitor that connect to the microprocessor, wherein the display device also comprises a menu presented on the monitor;

Step 402, connecting at least one image-capturing apparatus having an IP address to the Internet and using the image-capturing apparatus to capture an image of a predetermined area and produce a digital image signal, wherein the image-capturing apparatus comprises a responding device;

Step 403, using the broadcasting device settled in the display device to send out a preset command;

Step 404, using the responding device of the image-capturing apparatus to respond to the preset command so as to present the image-capturing apparatus in the menu of the display device;

Step 405, using the microprocessor settled in the display device to lock down the IP address of the image-capturing apparatus so as to make the digital image signal be captured and displayed;

Step 406, using the receiver settled in the display device to receive the digital image signal of the image-capturing apparatus; and

Step 407, using the monitor of the display device to display the digital image signal of the image-capturing apparatus.

Due to the cooperation of the broadcasting device and the responding device, each said display device can reach each said image-capturing apparatus in a same LAN automatically without a need of manual search.

Although the particular embodiments of the invention have been described in detail for purposes of illustration, it will be understood by one of ordinary skill in the art that numerous variations will be possible to the disclosed embodiments without going outside the scope of the invention as disclosed in the claims.

What is claimed is:

1. An image surveillance system connectable to an internet comprising:
at least one image-capturing apparatus connecting to the internet for capturing an image of a predetermined area to produce at least one digital image signal, wherein the image-capturing apparatus has an IP (Internet Protocol) address; and
at least one display device connecting to the internet and comprising:
a frame body, apparently resembling a conventional picture frame;
a search engine, settled in the frame body for searching the IP address of the image-capturing apparatus;
a receiver, deposited in the frame body for receiving the digital image signal from the image-capturing apparatus,
a monitor, deposited in the frame body for displaying the digital image signal of the image-capturing apparatus; and
a microprocessor, also disposed in the frame body and connecting to the search engine, the receiver, and the monitor to lock down the IP address of the image-capturing apparatus so as to make the digital image signal be captured and displayed.

2. The image surveillance system of claim 1, wherein the display device further comprises an input interface connecting to and controlling the microprocessor.

3. The image surveillance system of claim 2, wherein the input interface serves to input the IP address of the image-capturing apparatus.

4. The image surveillance system of claim 2, wherein the input interface externally connects to the display device.

5. The image surveillance system of claim 2, wherein the input interface is settled on the display device.

6. The image surveillance system of claim 1, further comprising a storage device settled in the frame body for storing the digital image signal of the image-capturing apparatus.

7. The image surveillance system of claim 1, wherein the image-capturing apparatus is an IP camera.

8. The image surveillance system of claim 1, wherein the image-capturing apparatus is a digital picture frame and further comprises a memory card socket for receiving a memory card.

9. The image surveillance system of claim 1, wherein the display device and the internet are connected mutually relying on a Wi-Fi (Wireless fidelity) technology, an infrared technology, an RF (Radio Frequency) technology or a BlueTooth technology.

10. The image surveillance system of claim 1, wherein the image-capturing apparatus and the display device are connected mutually relying on a TCP/IP (Transmission Control Protocol/Internet Protocol).

11. The image surveillance system of claim 1, wherein the image-capturing apparatus further comprises a security mechanism and the display device further includes a transmitter connecting to the microprocessor for transmitting an information conforming to the security mechanism so that the display device is allowed to capture the digital image signal from the image-capturing apparatus.

12. The image surveillance system of claim 11, wherein the information transmitted by the transmitter of the display device is a preset code.

13. The image surveillance system of claim 11, wherein the information transmitted by the transmitter of the display device is stored in the display device.

14. The image surveillance system of claim 11, wherein the information transmitted by the transmitter of the display device is input to the display device through an input interface.

15. An image surveillance system connectable to an internet comprising:
at least one image-capturing apparatus connecting to the internet for capturing an image of a predetermined area to produce at least one digital image signal, wherein the image-capturing apparatus has an IP (Internet Protocol) address; and
at least one display device connecting to the internet and comprising:
a frame body, apparently resembling a conventional picture frame;
a broadcasting device, settled in the frame body for sending out a preset command to the image-capturing apparatus;
a receiver, settled in the frame body for receiving the digital image signal from the image-capturing apparatus;
a monitor, settled on the frame body for displaying the digital image signal of the image-capturing apparatus;
a menu, for being displayed on the monitor; and
a microprocessor, settled in the frame body and connecting to the broadcasting device, the receiver as well as the monitor, for locking down the IP address of the image-capturing apparatus so as to make the digital image signal be captured and displayed;
wherein the image-capturing apparatus further comprises a responding device so that when receiving the preset command from the display device, the responding device respond with a preset information so as to present the image-capturing apparatus in the menu of the display device.

16. The image surveillance system of claim 15, wherein the display device further comprises an input interface connecting to and controlling the microprocessor.

17. The image surveillance system of claim 16, wherein the input interface selects a said image-capturing apparatus from the menu of the display device so as to capture and display the digital image signal of the selected image-capturing apparatus.

18. The image surveillance system of claim 15, wherein a data transmission between the image-capturing apparatus and the display device relies on a UDP (User Datagram Protocol).

19. An image surveillance method, comprising steps of:
providing a display device, which comprises a microprocessor and a search engine, a receiver, a broadcasting device as well as a monitor that connect to the microprocessor, wherein the display device also comprises a menu presented on the monitor;
connecting at least one image-capturing apparatus having an IP address to an internet and using the image-capturing apparatus to capture an image of a predetermined area and produce a digital image signal, wherein the image-capturing apparatus comprises a responding device;
using the broadcasting device settled in the display device to send out a preset command;
using the responding device of the image-capturing apparatus to respond to the preset command so as to present the image-capturing apparatus in the menu of the display device;
using the microprocessor settled in the display device to lock down the IP address of the image-capturing apparatus so as to make the digital image signal be captured and displayed;
using the receiver settled in the display device to receive the digital image signal of the image-capturing apparatus; and
using the monitor of the display device to display the digital image signal of the image-capturing apparatus.
